(19) United States
(12) Patent Application Publication
(10) Pub. No.: US 2008/0244275 A1
(43) Pub. Date: Oct. 2, 2008

(54) Instruction Transform for the Prevention and Propagation of Unauthorized Code Injection

(75) Inventor: Eric Ridvan Uner, Carpentersville, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/694,149

(22) Filed: Mar. 30, 2007

(51) Int. Cl. H04L 9/00

(52) U.S. Cl. 713/190

(57) ABSTRACT

A method and structure of instruction transformation. Applying the principals of biodiversity to instruction transformation applicable to devices and embedded systems and networks containing many devices not only protects individual devices from attack from unauthorized code, but additionally retards propagation of such unauthorized code to other devices in the system or network in communication with a potentially infected device.

### CROSS REFERENCE TO RELATED APPLICATIONS

The instant application is related to co-pending U.S. patent application Ser. No. 11/694,036, co-owned by assignee, and filed even date herewith, and being further identified by Attorney Docket No. CML02919E.

### BACKGROUND

The running of unauthorized software or code by a device can cause grave damage to that device or a network system containing devices in communication with one another. Unauthorized code is often developed for the purpose of causing harm to a device or computer system or network and can be very efficient in the deleterious effects it can cause. Such unauthorized code or synthetic code, also commonly referred to as malware, may include virus, worm, or Trojan code, may be any software attack that relies on inserting, altering, or substituting unauthorized code for authorized code that will be run by the target device, network or system. Malware can further propagate to any similar device reachable from an infected device, causing potentially catastrophic results not just for an infected device but for other devices within an embedded system or network, as well as the entire network itself.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an overview of a network or embedded system in which instruction transform is illustrated.

FIG. 2 is flow of a representative instruction transformation.

FIG. 3 is a flow of a representative static instruction transformation.

FIG. 4 is a flow of a representative dynamic instruction transformation.

FIG. 5 is a representative logical placement of an exemplary device.

FIG. 6 is a state diagram illustrating allowed transitions in an exemplary embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail example embodiments that are in accordance with the present invention, it should be observed that the embodiments reside primarily in combinations of method steps and apparatus components and related processes. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions described herein. The non-processor circuits may include, but are not limited to, a radio receiver, a radio transmitter, signal drivers, clock circuits, power source circuits, and user input devices. As such, these functions may be interpreted as a method to perform functions such as acquisition of a new policy in accordance with certain embodiments consistent with the present invention. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Instruction transform as described herein is applicable to providing increased protection from unauthorized or synthetic code to individual devices, as well as to the networks or embedded systems composed of such devices. Implementation of instruction transform in processors of devices used in embedded systems or network products provides many benefits as may be discussed. Examples of devices used in networks and embedded systems may range from mobile phones to two-way radios to single board computers used as servers or network infrastructure elements to routers and Internet appliances, etc.

Instruction transform introduces the concept of diversity into a device at the processor level to fight the overall effects and spreading of such unauthorized code from one device to another within the network. The concept of biodiversity in living creatures, whereby species of organisms are less susceptible to a disease if the disease cannot infect all members of the species if there are differences or diversity between group members, may be applied to networks and embedded systems having devices in communication with each other. By introducing diversity to the software image on a device level, a software attack that relies on inserting or altering instructions (unauthorized or synthetic code) would become very difficult.

This diversity manifests itself as a unique transform key unique to the device that each device uses to make its own code appear as near-random data to devices, which may have similar or like function, of the embedded system or network. An attack through the insertion, alteration or other use of unauthorized code becomes very difficult because the attacker would not know the transform key used to transform instructions for a given device. Moreover, instruction transform places a major hurdle to the propagation of unauthorized code from device to device within a network or embedded system. Even if the transform key is somehow discovered for one device, the transform key associated with each device of the network would not be known and thus malware could not easily spread within the embedded system or network. In this manner, instruction transform places a major hurdle to the would-be attackers of grouped devices within a network or system context.

As will be seen from the descriptions of various embodiments contained herein, the instruction transform described operates to not only protect an individual device from unauthorized or synthetic code, such as malware, viruses, worms or trojans, but to protect a network or embedded system having a plurality of devices, such as mobile phones, routers, Internet appliances, etc., which may often have like function. It is understood that the terms network and embedded system, as used herein, are both equally applicable to the described embodiments and to that extent may be used interchangeably. Devices within the embedded system or network may have similar or like function, such as cellular telephones operating in a cellular network, though this is not a requirement.

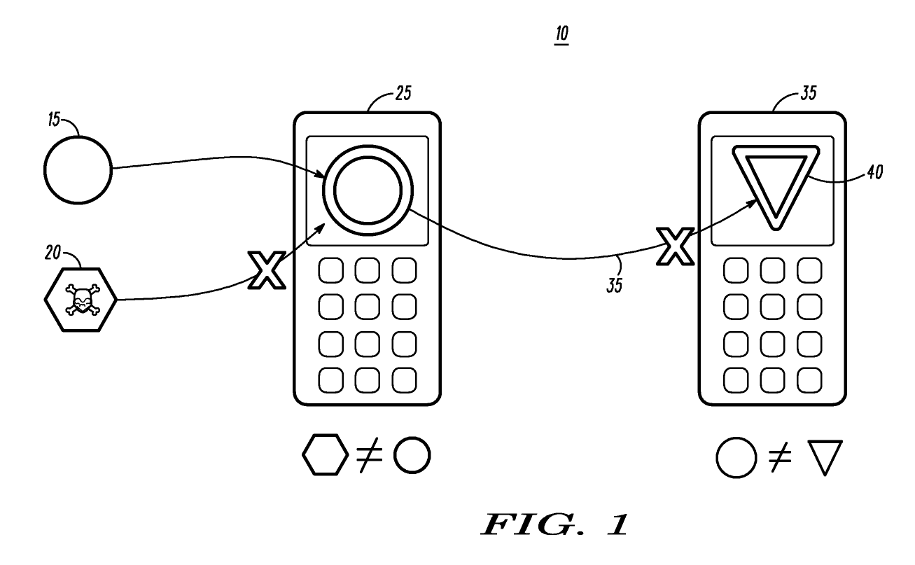

Referring to FIG. 1, an overview of a network or embedded system 10 in which instruction transform is employed is illustrated. It can be seen that there are two devices, 25 and 35. Each device 25 and 35 transforms trusted code into a distinct form that the processor of the device will accept and execute; non-transformed code cannot be executed properly and is interpreted by the device to which it is supplied as random data. Transformed and thus trusted code 15, represented by a circle, that has been transformed using the device transform key by the processor of device 25, which is thus trusted code and will be executed by the processor of device 25. Non-transformed code 20, represented by a hexagon, has not been transformed by the device transform key of device 25, is not trusted code, and thus will not be executed by the processor of device 25, as indicated by the “X” on the line from non-transformed code 20 to device 25. This is further illustrated by the legend which indicates that the hexagon (non-transformed code 20) does not equal the circle (transformed and thus trusted code 15). The propagation of untrusted (non-transformed code) between devices of the network is also hampered. It can be seen that although code 15 is trusted by device 25, it is not trusted by subsequent device 35, also illustrated by the “X” on the line 30 from transformed and thus trusted code 15 executable by device 25 to device 35, where it is has not been transformed by the device transform key of device 35 and thus, from the perspective of device 35, is non-transformed and thus untrusted code that looks like random data to target device 35. The trusted code that has been transformed by the device transform key of device 35 and thus will be executed by the processor of device 35 is transformed code 40, represented by the upside down triangle. A legend of this figure states that transformed and thus trusted code 15 does not equal trusted code 40, illustrated as an upside down triangle. It can be seen that code transformed by one device, such as code 15, will not executed properly on other devices for which it has not be transformed. In this way, the spread of unauthorized code, such as trojans, viruses, malware, etc., from device to device within a network is hampered.

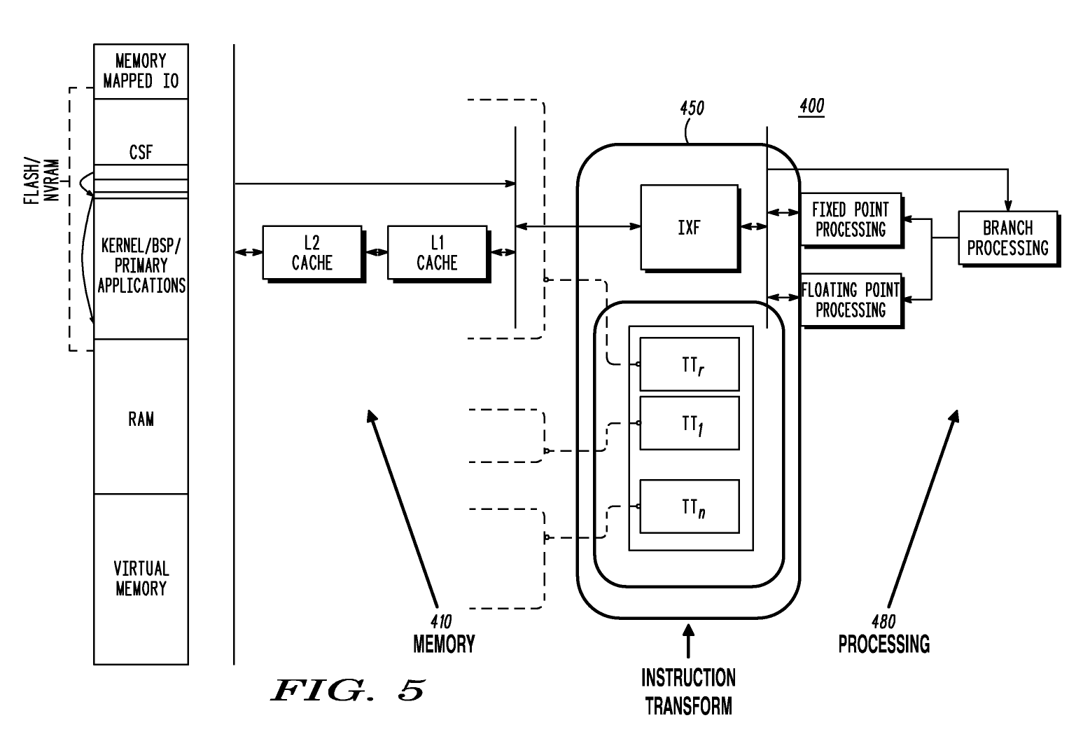

It can be seen that a device capable of executing code and operating in an embedded system having a plurality of other devices, which may or may not be of like function, benefits from instruction transform. The device, as further illustrated in FIG. 5, has processing ability provided by a processor and a device transform key unique to the device and in cooperative arrangement with the processor. The code to be executed by the device must be trusted (authorized code) that is transformed by the processor of device using the device transform key to generate transformed code. When the processor is placed in an authorized code mode, such as a mode in which it will execute authorized code, will run only the transformed code. It is noted that there may be other modes of operation of the device in which it may, for instance, run ROM (read only memory) code or even untransformed regions of code in certain circumstances.

In FIG. 5, a representative logical placement of an exemplary device 400 is illustrated. It can be seen that there are memory block 410, instruction transform block 450, and processing block 480 of a device in accordance with certain embodiments. The instruction transform functionality 450 resides between memory 410 and the processor block 480. In the particular example of the drawing, it can be seen that transform tables (TTᵣ, TT₁, . . . TTₙ) are employed but as will be described later, for instruction transform block 450, any storage mechanism, including tables, may be used. A transformation table that describes the memory addresses to transform and maintains the device transform key(s) in a manner inaccessible to any unauthorized software may be used. The transform functionality block 450, whether a transform table or note, may be functionally distinct from the processor block 480. For example, it is noted that the transform table may be distinct from the processor, allowing tighter address and state control. This serves to eliminate an attack on the transforming unit (processor) itself which might otherwise be manipulated to expand the effective address range to include malicious content for transformation or instant execution.

It is further noted that the transform table may be distinct from a memory management unit (MMU) of the device. This provides an advantage, in that because MMUs are easily reprogrammed by attackers and often used as an oracle for one application to encrypt instructions (unauthorized code) or data for use under the target MMU region. MMUs are accordingly not employed in embedded systems using true zero-copy or shared memory models.

Similarly, the arrangement of memory block 410 is meant by way of example and the particular arrangement of the memory function may be changed without departing from the spirit and scope of the invention. Similar comment applies to processor/processing block 480.

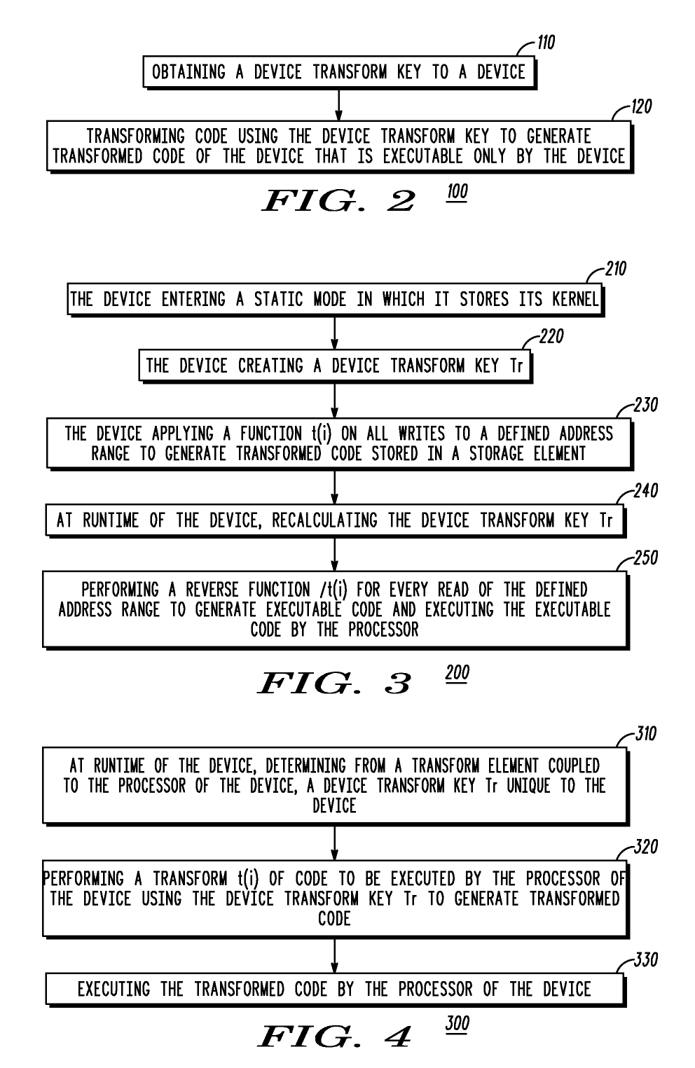

From the above, it can be seen that the methodology of instruction transform is illustrated at a high level by flow 100 of a device in FIG. 2. At Block 110, a device transform key unique to a device of the network or embedded system is obtained. Next, at Block 120, the device transform key is used to generate transformed code of the device that is recognized as trusted code and thus executable only by the device. The device transform key, which may be referred to as a root transform key, is unique to a device and used by the processor associated with the device to transform authorized code into transformed code trusted by the device. Control of the device transform key ensures that the processor will not execute unauthorized code such as might be provided to a device as malware, trojan software, viruses, etc. by attackers or hackers. The device transform key may be created at initial manufacturing of the device processor, after which time it is never exposed or made available to any entity other than the processor of the device. It is not stored with the program run by the processor. In addition to the device transform key being generated during manufacture of the device, it may also be generated after manufacturing, such as a one-time programmable key after manufacturing or post-manufacture programming. Moreover, the device transform key may even be Silicon based meaning that the device can even create its own device transform key that is probabilistically unique.

The device transform key may be an immutable root transform key unique to the device and may even be reproducible across boot cycles independent of any external storage, thereby providing a level of protection for execute-in-place code that is not possible if the key is stored along with the program where it is potentially accessible to attack.

Dynamic and Static Transformation

Instruction transform may employ dynamic transformation, static transformation, or some combination of the two. Dynamic transformation performs transformation of code with the device transform key of a device at load-time and does not require storage of transformed code. Static transformation involves transformation of code using the device transform key and then storage of such transformed code until needed. Using instruction transform, the devices is capable of performing all transformation of code rather than the software distributor. Static transformation at program time not only supports executing in place from non-volatile memory, but also supports massively parallel programming in a production environment. Adding dynamic transformation allows the device processor to support modern operating systems such as Linux or VxWorks that incorporate dynamically loaded executables from a mass storage device into RAM.

It is to be noted that the type of transformation to be employed, dynamic, static or some combination thereof, may itself by randomly selected, further enhancing the diversity among devices of the network or embedded system. In either case, code that has not be transformed using the device transform key into transformed, and thus authorized, code will not be executed by the processor of a particular device.

It can be seen that instruction transform provides different treatment for code and data during both static and dynamic transformation operations. This serves to prevent instruction transformation being misused as an oracle to transform data from one device into code for itself or for the processor of any other device.

Referring now to FIG. 3, a flow 200 of a representative static transformation is shown. In static instruction transform, authorized code may be transformed using the device transform key of a device to generate transformed code that is stored for future usage. At Block 210, the device enters a mode, which we may refer to as a static mode, in which it will store its kernel in a storage element. The device creates a device transform key Tr and then may apply a function t(i) using the device transform key Tr on all writes to a defined address range. The address range may be specified in a configuration file. Referring to Block 220, the device creates a device transform key Tr. The device applies a function t(i) using the device transform key Tr on all writes to a defined address range of the storage element to generate transformed code storage in the storage element at Block 230.

The transformation function t(i) may be any reversible function and may range from simple XOR operations to symmetric ciphers. Moreover, random selection of the transform function itself can add increased diversity among devices. The function t(i) may be a simple XOR operation or a fast symmetric cipher on all writes to an address range specified in a trusted configuration file or instructions received from a trusted path with (Tr+n), where n is the number of blocks from the start of the address range, or the result of some function ƒ(n); it is noted that n may be a number of sequential blocks from the start of the defined address range, although this is not required. Moreover, reversible function t(i) could simply be a reversible function using code words, perhaps a slightly weaker protection than that afforded by XOR or a symmetric cipher.

At this time, instruction transform makes no distinction between code and data. At runtime of the device, the device transform key is re-created by re-calculating the device transform key Tr at Block 240. The reverse function /t(i) can then be performed for every read of the defined address range, such as stored in the trusted configuration file, if used, at Block 250. The transformation key Tr is never stored in non-volatile memory nor in any external storage, or in a location readable by any software at runtime.

The device creates the device transform key Tr at Block 220 by using an immutable identification of the device, such as by inputting an immutable identification (ID) of the device to a cryptographic routine. The cryptographic routine may be a cryptographic one-way hash routine, for example. In this example, then, the device enters a mode where it stores its kernel, and then uses a secret, immutable ID inaccessible to software to input to a hash or cryptographic routine to create a root transform key Tr.

### Dynamic

Referring now to FIG. 4, flow 300 illustrates dynamic instruction transform as a methodology of protecting a device from executing unauthorized code. Dynamic instruction transformation allows protection from unauthorized code for dynamically loaded programs outside the kernel and is supported by the device processor's implementation of a transform element, such as a write-only transform element. It is noted that in many embedded systems, the kernel, board support package (BSP), and application(s) are monolithic, obviating the need for further instruction transform support. The extension of instruction transform to runtime programs supports operating systems such as Linux, as well as systems that compress or cipher portions of their software or systems that employ run-time compilation such as Java.

At Block 310, at runtime of the device, the device transform key Tr unique to the device is determined from a transform element coupled to or in cooperative arrangement with the processor of the device. At Block 320, a transform t(i) of the code to be executed by the processor is performed using the device transform key to generate transformed (authorized) code that will be recognized and can thus be executed by the device processor. The transformed code is executed by the processor of the device at Block 330.

A transformation function to be used by the processor to generate the transformed code is determined from the transformation element. As will be discussed, the transformation function used to generate the transformed code, as determined by the transformation element, may occur during static instruction transform, dynamic device transform, or some combination thereof. The device transform key is thus preferably maintained with the processor of the device.

In accordance with certain embodiments of the invention, a transformation function may be determined from the transform element and used to perform the transform of the code to generate the transformed code. The transform element may be a transform table readable by the processor and the transformation function may be a transformation function tag that indicates which of a plurality of transform functions to use on a range specified in a row of the transform table. The transform element may further comprise an address range indicating an address range of code to be transformed. Moreover, the transform element may further comprise address type information, wherein the address type information indicates whether the address range of code to be transformed is comprised of physical or virtual memory addresses. Furthermore, the transform element may be a write-only transform table readable by the processor of the device and the device transform key may be stored in a row of the transform table. While the transform element may be in table format, it is understood that any way in which necessary information is stored may be used. It will be seen that the transformation element may comprises one or more of an address range of the code to be transformed, an address type of the code to be transformed, and a transform state defining permissible transformation operations to generate the transformed code.

Consider the following with regard to an exemplary transform table (TT), as an example of a transformation element. The TT may contain the following fields or entries:

1. Address Range. This is an indication of over where the row in the TT has effect. This may be an optional field.

2. Address Type. Because both static and dynamic transformation environments may utilize virtual memory, the TT must indicate if the specified address range refers to physical or virtual memory addresses. Use of physical addresses offers increased security, as there is no need to temporarily inactivate a row in the TT to avoid address synonym confusion. Address synonym confusion occurs when virtual address ranges overlap for two different processes. Further, transformation on physical addresses can be performed at a later stage in which the virtual address may not be available, such as between an instruction unit(s) and level one L1 cache as illustrated in FIG. 5, for example.

3. Transform Key. The device transform key, or root transform key, may be used, together with the address offset, in the transform operations t(i) and /t(i). This field is writable by software to support swapping in of more TT entries than the TT table has rows. A special value, such as zero, may be used to create a random transform key that is guaranteed to be uncorrelated with the device transform key Tr. The use of a second, random transform key provides more security for dynamically loaded programs, such as Linux. Such a random transform key, however, is not available following a restart of the device, unlike the device transform key that is the same every time, even following a restart. A special row in the TT may contain Tr, which is never random nor writable, unlike a random transform key.

The use of a random transform key provides the ability to transform for write under the random transform key that can be disabled until a reset cycle. This prevents instruction transform being used as an oracle to transform data from one process into unauthorized code for itself or for any other process.

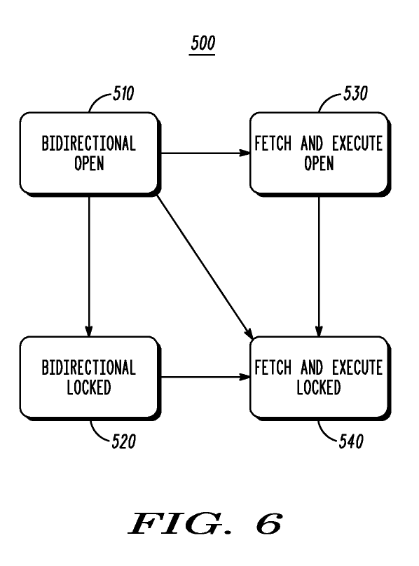

4. Transform State. The transform state defines which operations, related to a given row in the TT, are permitted by instruction transform. As indicated in the table below, various possible transform states are possible. As indicated in the state diagram of FIG. 6, not all state transitions are valid. Application developers can use the inescapability of the Fetch & Execute states to prevent instruction transform from being used as an oracle to transform data into code for execution.

| STATE | OPERATIONS |
|---|---|
| Bidirectional:: Open | Instruction transform will transform all |
| | data read from and written to the specified |
| | range. The row may be overwritten with |
| | new data. |
| Bidirectional::Lock | Instruction transform will transform all |
| | data read from and written to the specified |
| | range. The row may NOT be overwritten |
| | with new data. |
| Fetch & Execute::Open | Instruction transform will transform only |
| | instructions fetched from the specified |
| | range. The row may be overwritten with |
| | new data. |
| Fetch & Execute::Lock | Instruction transform will transform only |
| | instructions fetched from the specified |
| | range. The row may NOT be overwritten |
| | with new data. |

5. Transformation Function Tag. The transformation function tag indicates which of the available transform functions [{ƒ₀(i), /ƒ₀(i)} . . . {ƒₙ(i), /ƒₙ(i)}] that instruction transform should use on the range specified in this row. The special row TTr always uses fr(i), /fr(i), where r is either fixed or derived from the device transform key Tr, such as via a one-way hash operation, XOR, or a stronger cryptographic methodology, as previously discussed.

It is further noted that for the instruction transformation only, the Transform State and Address Range (if just dealing with a data stream) may not be needed and may be considered optional in this case.

As can be seen from the foregoing description of various embodiments, instruction transform operates to not only protect an individual device from unauthorized or synthetic code, such as malware, viruses, worms or trojans, but to protect a network or embedded system having a plurality of devices, such as mobile phones, routers, Internet appliances, etc., which may often have like function. Consider, for example, the use of a strong cryptographic method to cipher all the code in a device. The cryptography may be so robust that it takes attackers a year to thwart. Once this happens, however, every device within the network using the same cryptographic method is susceptible. Such might be case, for instance, to one windows virus being able to infect all Windows personal computers (PCs) that run the same version, because the addresses and values of code and data are the same across all similar PCs, even those PCs that employ a cryptographic method.

Using the instruction transform described herein, however, the introduction of diversity among similar devices of a network or embedded system certainly provides benefit to the device itself, as well as increased protection to the system or network as a whole. This diversity manifests itself as a unique transform key unique to the device that each device uses to make its own code appear as near-random data to other similar or like function devices of the embedded system or network.

Consider the following example, in which a network of 1,000 devices all run the same software. An attacker is able to defeat traditional protection techniques in 1,000 hours and thereafter has access to all 1,000 devices in the network. This is a huge problem that is addressed using the instruction transform described herein, wherein the attacker may only acquire access to one single device for the 1,000 of work. It would accordingly take the same attacker 1,000,000 hours (one thousand times as long) to repeat the attack on all devices and take control of the entire network. So, even if the instruction transform approach described herein uses a weaker defense on each individual device and the attacker takes only 10 hours to successfully penetrate the defenses of a single device, it would still take the attacker 10 times as long to propagate the attack to the entire network. In this particular example, it can be seen that the use of instruction transform may be used to provide medium robustness to a device but a very high degree of robustness from attack by unauthorized code to the network of devices.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of protecting a device from executing unauthorized code, comprising:
obtaining a device transform key unique to the device
transforming code to be executed by the device using the device transform key to generate transformed code in accordance with one or more of a static instruction transform operation and a dynamic instruction transform operation,
wherein the transformed code is executable only by the processor of the device.

2. The method of claim 1, wherein the device is one of a plurality of devices of an embedded system and wherein the transformed code of the device is not executable on other devices of the plurality of devices of the embedded system.

3. The method of claim 1, further comprising:
a transformation element defining the device transform key, the transformation element in cooperative arrangement with the processor of the device.

4. The method of claim 3, further comprising:
determining from the transformation element a transformation function to be used by the processor to generate the transformed code.

5. The method of claim 3, further comprising:
determining from the transformation element one or more of an address range of the code to be transformed, an address type of the code to be transformed, and a transform state defining permissible transformation operations to generate the transformed code.

6. The method of claim 3, wherein the transformation element is a write-only transform table controlled by the processor of the device.

7. The method of claim 1, wherein selection of one or more of the static transform operation and the dynamic instruction transform operation is randomly selected.

8. The method of claim 1, further comprising:
the device entering a static mode in which its kernel is stored in a storage element;
the device creating the device transform key Tr;
the device applying a transformation function t(i) using the device transform key Tr on all writes to a defined address range of the storage element;
at runtime recreating the device transform key Tr;
the device performing a reverse function /t(i) using the device transform key Tr for every read of the defined address range.

9. The method of claim 8, wherein the device creates the device transform key Tr by inputting an immutable identification (ID) of the device to a cryptographic routine.

10. The method of claim 8, wherein the defined address range is specified in a configuration file.

11. The method of claim 8, wherein the defined address range is specified by instructions received from a path Tr+n, where n is a number of blocks from the start of the defined address range.

12. The method of claim 8, wherein the transformation function t(i) is a reversible function.

13. A method of claim 1, further comprising:
at runtime of the device, determining from a transform element coupled to the process of the device, the device transform key unique to the device;
performing a transform of code to be run by the processor of the device using the device transform key to generate transformed code;
executing the transformed code by the processor of the device.

14. The method of claim 13, wherein the transform element is a write-only transform table readable by the processor of the device and the device transform key is stored in a row of the transform table.

15. The method of claim 13, further comprising:
determining from the transform element a transformation function to be used in performing the transform of the code to generate the transformed code.

16. The method of claim 15, wherein the transform element is a transform table readable by the processor and the transformation function is a transformation function tag that indicates which of a plurality of transform functions to use on a range specified in a row of the transform table.

17. The method of claim 13, wherein the transform element further comprises an address range indicating an address range of code to be transformed.

18. The method of claim 13, wherein the transform element further comprises address type information, wherein the address type information indicates whether the address range of code to be transformed is comprised of physical or virtual memory addresses.

19. A method of protecting a device having a processor capable of executing code from executing unauthorized code, comprising:
the device entering a static mode in which its kernel is stored in a storage element;
the device creating a device transform key Tr;
the device applying a transformation function t(i) using the device transform key Tr on all writes to a defined address range of the storage element at runtime recreating the device transform key Tr;
the device performing a reverse function /t(i) using the device transform key Tr for every read of the defined address range.

20. The method of claim 19, wherein the device creates the device transform key Tr by inputting an immutable identification (ID) of the device to a cryptographic routine.

21. The method of claim 19, wherein the defined address range is specified in a configuration file.

22. The method of claim 19, wherein the defined address range is specified by instructions received from a path Tr+n, where n is a number of blocks from the start of the defined address range.

23. The method of claim 19, wherein the transformation function t(i) is a reversible function.

24. A method of protecting a device having a processor capable of executing code from executing unauthorized code, comprising:
at runtime of the device, determining from a transform element coupled to the process of the device, a device transform key unique to the device;
performing a transform of code to be run by the processor of the device using the device transform key to generate transformed code;
executing the transformed code by the processor of the device.

25. The method of claim 24, wherein the transform element is a write-only transform table readable by the processor of the device and the device transform key is stored in a row of the transform table.

26. The method of claim 24, further comprising:
determining from the transform element a transformation function to be used in performing the transform of the code to generate the transformed code.

27. The method of claim 26, wherein the transform element is a transform table readable by the processor and the transformation function is a transformation function tag that indicates which of a plurality of transform functions to use on a range specified in a row of the transform table.

28. The method of claim 24, wherein the transform element further comprises an address range indicating an address range of code to be transformed.

29. The method of claim 24, wherein the transform element further comprises address type information, wherein the address type information indicates whether the address range of code to be transformed is comprised of physical or virtual memory addresses.
